(19) United States
(12) Patent Application Publication
(10) Pub. No.: US 2006/0208850 A1
(43) Pub. Date: Sep. 21, 2006

(54) Secondary battery protection circuit comprising a security arrangement

(75) Inventors: Akira Ikeuchi, Kanagawa (JP); Daisuke Kimura, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 11/342,422

(22) Filed: Jan. 30, 2006

(30) Foreign Application Priority Data
Mar. 14, 2005 (JP) 2005-70867

(51) Int. Cl. G05B 19/00; H02J 7/00; G08B 21/00

(52) U.S. Cl. 340/5.8; 340/636.1; 320/136

(57) ABSTRACT

In a secondary battery protection circuit (200A) having a protection arrangement (210, 220, 230, 240, 250A) for protecting a secondary battery (300), by turning a discharge control switch (FET1) and a charge control switch (FET2) on and off, so as to prevent the secondary battery from overdischarging and overcharging, the secondary battery protection circuit further has a security arrangement (260, 270) for precluding counterfeit goods of a secondary pack. The security arrangement has an interface circuit (260) for interfacing to a portable unit body (500) and an authentication circuit (270) for calculating an identifier obtained by encrypting a random number received from the portable unit body to return the identifier to the portable unit body.

This application claims priority to prior application JP 2005-70867, the disclosure of which is incorporated herein by reference.

### BACKGROUND OF THE INVENTION

This invention relates to a secondary or rechargeable battery protection circuit for use in a battery unit comprising at least one chargeable electric cell (secondary battery) such as a lithium ion cell and, in particular, to a secondary battery protection circuit with a security function.

Among various types of chargeable electric cells, a lithium ion cell is particularly weak against overdischarge or overcharge. In this connection, it is essential to provide a secondary battery protection circuit for detecting an overdischarge condition and an overcharge condition to protect a secondary battery from the overdischarge condition and the overcharge condition. For this purpose, the secondary battery protection circuit comprises an overdischarge detection circuit and an overcharge detection circuit. Such a secondary battery protection circuit is disclosed, for example, in U.S. Pat. No. 6,340,880 issued to Yasuhisa Higashijima et al. In addition, the secondary battery protection circuit may detect an overcurrent condition during discharge of the secondary battery to protect the secondary cell from the overcurrent condition. In this event, the secondary battery protection circuit may comprise an overcurrent detection circuit as well as the overdischarge detection circuit and the overcharge detection circuit. Such a secondary battery protection circuit is disclosed, for example, in U.S. Pat. No. 6,642,694 issued to Yuji Yamanaka et al. Furthermore, the secondary battery protection circuit further may comprise a short-circuit detection circuit. Such a secondary battery protection circuit is disclosed, for example, in Japanese Unexamined Patent Application Publication of Tokkai No. 2002-272001 or JP-A 2002-272001.

In the manner which will later be described in conjunction with FIGS. 1 and 2, a conventional battery unit comprises the above-mentioned secondary battery protection circuit, a secondary battery, a discharge control switch, and a charge control switch. The battery unit is also called a battery pack in the art. The discharge control switch and the charge control switch comprise first and second metal oxide semiconductor field effect transistors (MOSFETs) containing first and second parasitic diodes, respectively. The first parasitic diode is connected to the first MOSFET so that a forward direction of the first parasitic diode coincides with a charging direction of the secondary battery. The second parasitic diode is connected to the second MOSFET so that a forward direction of the second parasitic diode coincides with a discharging direction of the secondary battery. Each of the first and the second parasitic diodes is called a body diode. Such a battery unit or pack is disclosed, for example, in Japanese Granted Patent Publication of No. 2,872,365 or JP-B 2872365 under the title of “CHARGEABLE POWER UNIT.”

Such a battery pack is disadvantageous in that it is possible to easily manufacture counterfeit goods of the battery pack. This is because the battery pack comprises no security function. Among this specification, the “security function” means a function for precluding inferior and dangerous counterfeit goods to improve safety in the secondary battery. In other words, the security function means a function for certificating or authenticating a security identifier (ID) to preclude, as the counterfeit goods, ones which cannot certificate or authenticate the security ID. In the conventional battery pack, it is possible to easily manufacture the counterfeit goods thereof. This is because the conventional battery pack has no function for certificating or authenticating the security ID.

For this purpose, a proposal is made a new battery pack with an integrated circuit (IC) or a microcomputer for the security function. Such a new battery pack is called a security-equipped battery pack. It is difficult for the security-equipped battery pack to manufacture counterfeit goods thereof. However, in the manner which will later be described in conjunction with FIGS. 3 through 5 in detail, it is feared that the following problems occur in the proposed or related security-equipped battery pack. That is, the related security-equipped battery pack comprises not only the above-mentioned conventional secondary battery protection circuit but also a purpose-built security circuit with a security function for authenticating the security ID and external circuitry which are mounted on a protection board. As a result, a lot of parts are required and a mounted area occupied on the protection board is large. It is therefore disadvantageous in that the related security-equipped battery pack increases in cost greatly on the whole. In addition, inasmuch as turning-on/off of the battery pack in itself is carried out by the secondary battery protection circuit, turning-on/off caused by the ID authentication using the security circuit is controlled by portable unit bodies such as cellular phones side. Accordingly, it is impossible to power off by the battery pack singly.

### SUMMARY OF THE INVENTION

It is therefore an object of the present invention to provide a secondary battery protection circuit with a security function that is capable of making full use of the security function with a low parts count.

Other objects of this invention will become clear as the description proceeds.

According to an aspect of this invention, a secondary battery protection circuit comprises a protection arrangement for protecting a secondary battery, by turning a discharge control switch and a charge control switch on and off, so as to prevent the secondary battery from overdischarging and overcharging, and a security arrangement for precluding counterfeit goods of a battery pack.

In the afore-mentioned secondary battery protection circuit, the protection arrangement may comprise an overdischarge detection circuit for detecting an overdischarge in the secondary battery, an overcharge detection circuit for detecting an overcharge in the secondary battery, and a protection control logic circuit, connected to the overdischarge detection circuit and the overcharge detection circuit, for controlling turning-on/off of the discharge control switch and the charge control switch. The security arrangement may comprise an interface circuit for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

In the afore-mentioned secondary battery protection circuit, the protection arrangement may comprise an overdischarge detection circuit for detecting an overdischarge in the secondary battery, an overcharge detection circuit for detecting an overcharge in the secondary battery, an overcurrent detection circuit for detecting an overcurrent in the secondary battery, and a protection control logic circuit, connected to the overdischarge detection circuit, the overcharge detection circuit, and the overcurrent detection circuit, for controlling turning-on/off of the discharge control switch and the charge control switch. The security arrangement may comprise an interface circuit for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

In the afore-mentioned secondary battery protection circuit, the protection arrangement may comprise an overdischarge detection circuit for detecting an overdischarge in the secondary battery, an overcharge detection circuit for detecting an overcharge in the secondary battery, a short-circuit detection circuit for detecting a short circuit between external connection terminals, and a protection control logic circuit, connected to the overdischarge detection circuit, the overcharge detection circuit, and the short-circuit detection circuit, for controlling turning-on/off of the discharge control switch and the charge control switch. The security arrangement may comprise an interface circuit for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

In the afore-mentioned secondary battery protection circuit, the protection arrangement may comprise an overdischarge detection circuit for detecting an overdischarge in the secondary battery, an overcharge detection circuit for detecting an overcharge in the secondary battery, an overcurrent detection circuit for detecting an overcurrent in the secondary battery, a short-circuit detection circuit for detecting a short circuit between external connection terminals, and a protection control logic circuit, connected to the overdischarge detection circuit, the overcharge detection circuit, the overcurrent detection circuit, and the short-circuit detection circuit, for controlling turning-on/off of the discharge control switch and the charge control switch. The security arrangement may comprise an interface circuit for interfacing to a portable unit body and an authentication circuit, connected to the interface circuit, for calculating an identifier obtained by encrypting a random number received from a portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

On describing the gist another aspect of this invention, it is possible to be understood that a security-equipped battery pack has a pack positive electrode terminal, a pack negative electrode terminal and a pack input/output terminal. The security-equipped battery pack comprises a secondary battery having a cathode connected to the pack positive electrode terminal and an anode, a discharge control switch and a charge control switch, disposed between the anode and the pack negative electrode terminal, connected in series with each other. The discharge control switch has a discharge control terminal. The charge control switch has a charge control terminal. The security-equipped battery pack comprises a security-equipped secondary battery protection circuit which has a protection power source terminal connected to the cathode through a first resistor, a protection ground terminal connected to the anode, an overdischarge detection output terminal connected to the discharge control terminal, an overcharge detection output terminal connected to the charge control terminal, and a protection input/output terminal connected to the pack input/output terminal.

According to the other aspect of this invention, the above-understood security-equipped secondary battery protection circuit comprises a protection arrangement, connected to the protection power source terminal, the overdischarge detection output terminal, and the overcharge detection output terminal, for protecting the secondary battery, by turning the discharge control switch and the charge control switch on and off, so as to prevent the secondary battery from overdischarging and overcharging, and a security arrangement, connected to the protection input/output terminal, for precluding counterfeit goods of a secondary pack.

In the afore-mentioned security-equipped battery pack, the protection arrangement may comprise an overdischarge detection circuit, connected to the protection power source terminal, for detecting an overdischarge in the secondary battery, an overcharge detection circuit, connected the protection power source terminal, for detecting an overcharge in the secondary battery, and a protection control logic circuit, connected to the overdischarge detection circuit, the overcharge detection circuit, the overdischarge detection output terminal, and the overcharge detection output terminal, for controlling turning-on/off of the discharge control switch and the charge control switch. The security arrangement may comprise an interface circuit, connected to the protection input/output terminal, for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

In the afore-mentioned security-equipped battery pack, the security-equipped secondary battery protection circuit further may have an detection input terminal connected to the pack negative electrode terminal through a second resistor. The protection arrangement may comprise an overdischarge detection circuit, connected to the protection power source terminal, for detecting an overdischarge in the secondary battery, an overcharge detection circuit, connected the protection power source terminal, for detecting an overcharge in the secondary battery, an overcurrent detection circuit, connected to the detection input terminal, for detecting an overcurrent in the secondary battery, and a protection control logic circuit, connected to the overdischarge detection circuit, the overcharge detection circuit, the overcurrent detection circuit, the overdischarge detection output terminal, and the overcharge detection output terminal, for controlling turning-on/off of the discharge control switch and the charge control switch. The security arrangement may comprise an interface circuit, connected to the protection input/output terminal, for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

In the afore-mentioned security-equipped battery pack, the security-equipped secondary battery protection circuit further may have an detection input terminal connected to the pack negative electrode terminal through a second resistor. The protection arrangement may comprise an overdischarge detection circuit, connected to the protection power source terminal, for detecting an overdischarge in the secondary battery, an overcharge detection circuit, connected the protection power source terminal, for detecting an overcharge in the secondary battery, a short-circuit detection circuit, connected to the detection input terminal, for detecting a short circuit between the pack positive electrode terminal and the pack negative electrode terminal, and a protection control logic circuit, connected to the overdischarge detection circuit, the overcharge detection circuit, the short-circuit detection circuit, the overdischarge detection output terminal, and the overcharge detection output terminal, for controlling turning-on/off of the discharge control switch and the charge control switch. The security arrangement may comprise an interface circuit, connected to the protection input/output terminal, for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

In the afore-mentioned security-equipped battery pack, the security-equipped secondary battery protection circuit further may have an detection input terminal connected to the pack negative electrode terminal through a second resistor. The protection arrangement may comprise an overdischarge detection circuit, connected to the protection power source terminal, for detecting an overdischarge in the secondary battery, an overcharge detection circuit, connected the protection power source terminal, for detecting an overcharge in the secondary battery, an overcurrent detection circuit, connected to the detection input terminal, for detecting an overcurrent in the secondary battery, a short-circuit detection circuit, connected to the detection input terminal, for detecting a short circuit between the pack positive electrode terminal and the pack negative electrode terminal, and a protection control logic circuit, connected to the overdischarge detection circuit, the overcharge detection circuit, the overcurrent detection circuit, the short-circuit detection circuit, the overdischarge detection output terminal, and the overcharge detection output terminal, for controlling turning-on/off of the discharge control switch and the charge control switch. The security arrangement may comprise an interface circuit, connected to the protection input/output terminal, for interfacing to a portable unit body and an authentication circuit, connected to the interface circuit, for calculating an identifier obtained by encrypting a random number received from the portable unit body to return the identifier to the portable unit body. The authentication circuit may be connected to the protection control logic circuit. In this event, the authentication circuit preferably may make the protection control logic circuit turn at least one of the discharge control switch and the charge control switch off when decision of the counterfeit goods is made.

### BRIEF DESCRIPTION OF THE DRAWING

FIG. 1 is a block diagram of a conventional battery pack without a security function;

FIG. 2 is a view for use in describing operation of the conventional battery pack illustrated in FIG. 1;

FIG. 3 is a block diagram of a related security-equipped battery pack;

FIG. 4 is a view showing a state where the related security-equipped battery pack is connected to a portable unit body;

FIG. 5 is a flow chart for use in describing an example (a challenge response scheme) of the security function in the related security-equipped battery pack illustrated in FIG. 3;

FIG. 6 is a block diagram of a security-equipped battery pack comprising a security-equipped secondary battery protection circuit according to an embodiment of this invention;

FIG. 7 is a view showing a state where the security-equipped battery pack is connected to a portable unit body;

FIG. 8 is a flow chart for use in describing a first example (a challenge response scheme) of the security function in the security-equipped battery pack illustrated in FIG. 6;

FIG. 9 is a flow chart for use in describing a second example (a continuous challenge scheme) of the security function in the security-equipped battery pack illustrated in FIG. 6; and

FIG. 10 is a flow chart for use in describing a third example (a continuous response scheme) of the security function in the security-equipped battery pack illustrated in FIG. 6.

### DESCRIPTION OF THE PREFERRED EMBODIMENT

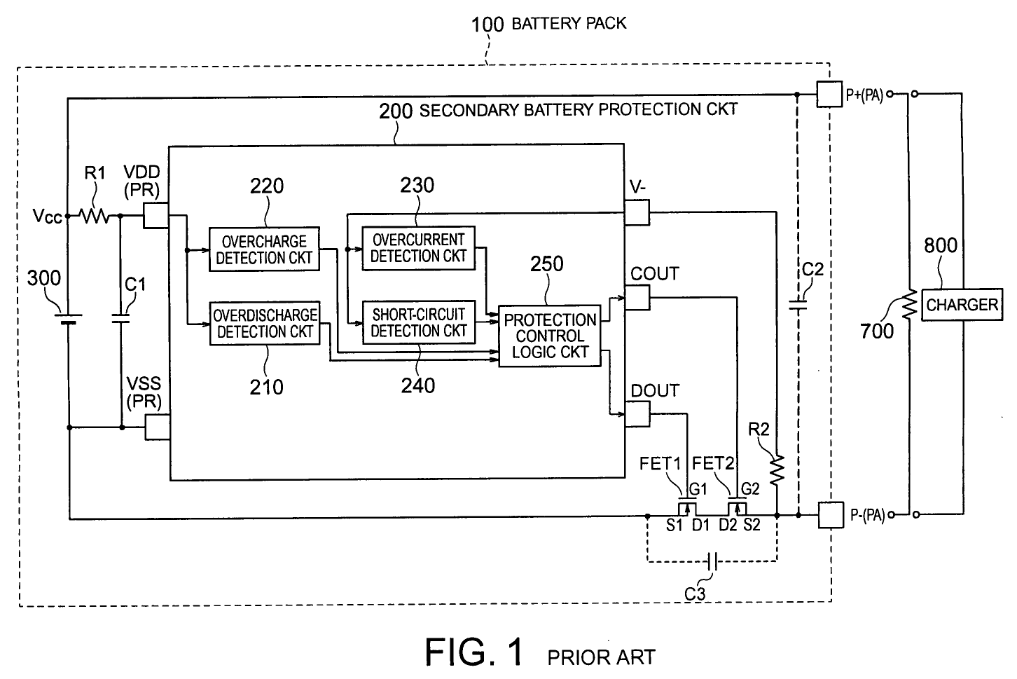

Referring to FIG. 1, a conventional battery unit 100 comprising a conventional secondary battery protection circuit 200 will be described at first in order to facilitate an understanding of the present invention.

The battery unit 100 may be called a battery pack. The battery pack 100 has a pair of external connection terminals (pack electrode terminals) P+(PA) and P−(PA) between which a load 700 or a charger 800 is connected. In the pair of external connection terminals, one is a pack positive electrode terminal P+(PA) and another is a pack negative electrode terminal P−(PA). Between the pack positive electrode terminal P+(PA) and the pack negative electrode terminal P−(PA), the load 700 or the charger 800 are selectively connected.

The illustrated battery unit or pack 100 comprises a secondary battery 300 including at least one lithium ion cell (which is also called a unit cell). The secondary battery 300 is connected between a protection power source terminal VDD(PR) and a protection ground terminal VSS(PR) to generate a battery voltage Vcc. In other words, the secondary battery 300 has a cathode connected to the protection power source terminal VDD(PR) and an anode connected to the protection ground terminal VSS(PR). The protection power source terminal VDD(PR) is connected to the pack positive electrode terminal P+(PA) through a resistor R1. The secondary battery 300 is connected in parallel with the secondary battery protection circuit 200.

More specifically, the secondary battery protection circuit 200 has the protection power source terminal VDD(PR), the protection ground terminal VSS(PR), an overdischarge detection output terminal DOUT, an overcharge detection output terminal COUT, and a detection input terminal V−. The secondary battery 300 has the cathode which is connected to the protection power source terminal VDD(PR) of the secondary battery protection circuit 200 through the resistor R1. The secondary battery 200 has the anode which is directly connected to the protection ground terminal VSS(PR) of the secondary battery protection circuit 200. Between the protection power source terminal VDD(PR) and the protection ground terminal VSS(PR), a capacitor C1 is connected. In addition, the cathode of the secondary battery 300 is connected to the pack positive electrode terminal P+(PA) of the battery pack 100. The anode of the secondary battery 300 is grounded and is connected to the pack negative electrode terminal P−(PA) of the battery pack 100 through first and second field effect transistors FET1 and FET2 which will later be described.

The secondary battery protection circuit 200 comprises an overdischarge detection circuit 210, an overcharge detection circuit 220, an overcurrent detection circuit 230, a short-circuit detection circuit 240, and a protection control logic circuit 250.

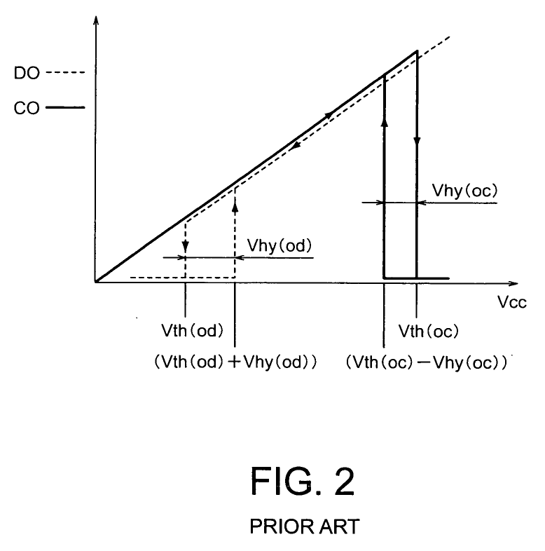

Referring to FIG. 2 in addition to FIG. 1, the overdischarge detection circuit 210 is set with an overdischarge detection threshold voltage Vth(od). Specifically, the overdischarge detection circuit 210 compares the battery voltage Vcc with the overdischarge detection threshold voltage Vth(od) during discharge. When the battery voltage Vcc is lower than the overdischarge detection threshold voltage Vth(od), the overdischarge detection circuit 210 judges that the secondary battery 300 is put into an “overdischarge condition” to send an overdischarge detected signal having a logic low level to the logic circuit 25. Responsive to the overdischarge detected signal, the protection control logic circuit 250 produces a signal of a logic low level from the overdischarge detection output terminal (a first gate drive terminal) DOUT. On the other hand, during discharge, when the battery voltage Vcc is higher than an overdischarge return voltage (Vth(od)+Vhy(od)) obtained by adding an overdischarge hysteresis voltage Vhy(od) to the overdischarge detection threshold voltage Vth(od), the overdischarge detection circuit 210 sends an overdischarge protection cancellation signal having a logic high level to the protection control logic circuit 250. Responsive to the overdischarge protection cancellation signal, the protection control logic circuit 250 produces a signal of the logic high level from the overdischarge detection output terminal DOUT.

Likewise, the overcharge detection circuit 220 is set with an overcharge detection threshold voltage Vth(oc). Specifically, the overcharge detection circuit 210 compares the battery voltage Vcc with the overcharge detection threshold voltage Vth(oc) during charge. When the battery voltage Vcc is higher than the overcharge detection threshold voltage Vth(oc), the overcharge detection circuit 220 judges that the secondary battery 300 is put into an “overcharge condition” to send an overcharge detected signal having a logic low level to the protection control logic circuit 250. Responsive to the overcharge detected signal, the protection control logic circuit 250 produces a signal of the logic low level from the overcharge detection output terminal (a second gate drive terminal) COUT. On the other hand, during charge, when the battery voltage Vcc is lower than an overcharge return voltage (Vth(oc)−Vhy(oc)) obtained by subtracting an overcharge hysteresis voltage Vhy(oc) from the overcharge detection threshold voltage Vth(oc), the overcharge detection circuit 220 sends an overcharge protection cancellation signal having a logic high level to the protection control logic circuit 250. Responsive to the overcharge protection cancellation signal, the protection control logic circuit 250 produces a signal of the logic high level from the overcharge detection output terminal COUT.

In the manner which is described above, between the anode (an minus electrode) of the secondary battery 300 and the pack negative electrode terminal P−(PA) of the battery pack 100, the first and the second field effect transistors FET1 and FET2 are connected in series with each other. The first field effect transistor FET1 is operable as a discharge control FET or a discharge control switch while the second field effect transistor FET2 is operable as a charge control FET or a charge control switch. In the example being illustrated, each of the first and the second field effect transistors FET1 and FET2 consists of an n-channel metal oxide semiconductor field effect transistor (MOSFET). The first field effect transistor FET1 has a first source S1 connected to the anode of the secondary battery 300 or the ground terminal, a first gate G1 connected to the overdischarge detection output terminal DOUT of the secondary battery protection circuit 200, and a first drain D1. The first gate G1 of the first field effect transistor FET1 is operable as a first or discharge control terminal of the discharge control switch. The second field effect transistor FET2 has a second source S2 connected to the pack negative electrode terminal P−(PA), a second gate G2 connected to the overcharge detection output terminal COUT of the secondary battery protection circuit 200, and a second drain D2 connected to the first drain D1 of the first field effect transistor FET1. The second gate G2 of the second field effect transistor FET2 is operable as a second or charge control terminal of the charge control switch. An arrangement of the first and the second field effect transistors FET1 and FET2 may be exchanged.

When the first gate G1 of the first field effect transistor FET1 is supplied with the signal having the logic low level from the overdischarge detection output terminal DOUT, the first field effect transistor FET1 is turned off. On the other hand, when the first gate G1 of the first field effect transistor FET1 is supplied with the having the logic high level from the overdischarge detection output terminal DOUT, the first field effect transistor FET1 is turned on. Similarly, when the second gate G2 of the second field effect transistor FET2 is supplied with the signal having the logic low level from the overcharge detection output terminal COUT, the second field effect transistor FET2 is turned off. When the second gate G2 of the second field effect transistor FET2 is supplied with the signal having the logic high level from the overcharge detection output terminal COUT, the second field effect transistor FET2 is turned on.

Although illustration is omitted from FIG. 1, in the manner which is described in the above-mentioned JP-B 2872365, the first field effect transistor FET1 has a first parasitic diode while the second field effect transistor FET2 has a second parasitic diode. The first parasitic diode is connected in parallel with the first field effect transistor FET1 so that a forward direction of the first parasitic diode coincides with a charging direction of the secondary battery 300. That is, the first parasitic diode has a first anode connected to the first source S1 of the first field effect transistor FET1 and a first cathode connected to the first drain D1 of the first field effect transistor FET1. The second parasitic diode is connected in parallel with the second field effect transistor FET2 so that a forward direction of the second parasitic diode coincides with a discharging direction of the secondary battery 300. That is, the second parasitic diode has a second anode connected to the second source S2 of the second field effect transistor FET2 and a second cathode connected to the second drain D2 of the second field effect transistor FET2.

Referring now to FIG. 2 in addition to FIG. 1, description will be made as regards operation of the battery unit (the battery pack) 100 illustrated in FIG. 1. In FIG. 2, the abscissa represents the battery voltage Vcc and the ordinate represents an output DO of the overdischarge detection circuit 210 or an output CO of the overcharge detection circuit 220. In FIG. 2, a broken line represents an output characteristic of the overdischarge detection circuit 210 on discharging while a solid line represents an output characteristic of the overcharge detection circuit 220 on charging. An operation on discharging will be first described and an operation on charging will be successively described.

On discharging of the battery pack 100, the load 700 is connected between the pack positive electrode terminal P+(PA) and the pack negative electrode terminal P−(PA). While the secondary battery 300 is discharged, as shown in the broken line in FIG. 2, the battery voltage Vcc of the secondary battery 300 becomes gradually low. When the battery voltage Vcc is finally lower than the overdischarge detection threshold voltage Vth(od), the overdischarge detection circuit 210 produces the overdischarge detected signal having the logic low level. Responsive to the overdischarge detected signal, the protection control logic circuit 250 sends the signal of the logic low level from the overdischarge detection output terminal DOUT to the first gate G1 of the first field effect transistor FET1. Thereby, the first field effect transistor FET1 is turned off and the overdischarge is prevented.

When an effect that the secondary battery 300 is put into an overdischarge condition is notified to a user by any notification arrangement, the user removes the load 700 from the external connection terminals P+(PA) and P−(PA) and connects the charger 800 for the load 700 with the external connection terminals P+(PA) and P−(PA). Accordingly, charging of the secondary battery 300 starts. In this event, a charging current flows through the first parasitic diode in the first field effect transistor FET1. Thereafter, when the battery voltage Vcc of the secondary battery 300 is higher than the overdischarge return voltage (Vth(od)+Vhy(od)), the overdischarge detection circuit 210 produces the overdischarge protection cancellation signal having the logic high level. Responsive to the overdischarge protection cancellation signal, the protection control logic circuit 250 sends the signal having the logic high level from the overdischarge detection output terminal DOUT to the first gate G1 of the first field effect transistor FET1. Thereby, the first field effect transistor FET1 is turned on.

Now, in the manner which is described above, while charging of the secondary battery 300 is continued, the battery voltage Vcc of the secondary battery 300 becomes gradually high, as shown in the solid line in FIG. 2. When the battery voltage Vcc is finally higher than the overcharge detection threshold voltage Vth(oc), the overcharge detection circuit 220 produces the overcharge detected signal having the logic low level. Responsive to the overcharge detected signal, the protection control logic circuit 250 sends the signal having the logic low level from the overcharge detection output terminal COUT to the second gate G2 of the second field effect transistor FET2. Thereby, the second field effect transistor FET2 is turned off and the overcharge is prevented.

When an effect that the secondary battery 300 is put into an overcharge condition is notified to a user by any notification arrangement, the user decides that the charging is completed. Thereafter, the user removes the charger 800 from the external connection terminals P+(PA) and P−(PA) and connects the load 700 for the charger 800 with the external connection terminals P+(PA) and P−(PA). Accordingly, discharging of the secondary battery 300 starts. In this event, a discharging current flows through the second parasitic diode in the second field effect transistor FET2. Thereafter, when the battery voltage Vcc of the secondary battery 300 is lower than the overcharge return voltage (Vth(oc)−Vhy(oc)), the overcharge detection circuit 220 produces the overcharge protection cancellation signal having the logic high level. Responsive to the overcharge protection cancellation signal, the protection control logic circuit 250 sends the signal having the logic high level from the overcharge detection output terminal COUT to the second gate G2 of the second field effect transistor FET2. Thereby, the second field effect transistor FET2 is turned on.

Turning back to FIG. 1, description will proceed to the overcurrent detection circuit 230 and the short-circuit detection circuit 240. The secondary battery protection circuit 200 has the detection input terminal V− in the manner which is described above. The detection input terminal V− is connected to the pack negative electrode terminal P−(PA) of the battery pack 100 through a resistor R2. In addition, a capacitor C2 may be connected between the pack positive electrode terminal P+(PA) and the pack negative electrode terminal P−(PA) of the battery pack 100 and a capacitor C3 may be connected between the pack negative electrode terminal P−(PA) of the battery pack 100 and the protection ground terminal VSS(PR). The capacitors C2 and C3 are for improving a resisting amount of voltage variations and extraneous noises.

The overcurrent detection circuit 230 is connected to the detection input terminal V−. When the overcurrent detection circuit 230 detects that an overcurrent flows as a discharge current on discharging, the overcurrent detection circuit 230 sends an overcurrent detected signal to the protection control logic circuit 250. Responsive to the overcurrent detected signal, the protection control logic circuit 250 sends the signal having the logic low level from the overdischarge detection output terminal DOUT to the first gate G1 of the first field effect transistor FET1. Thereby, the first field effect transistor FET1 is turned off, the discharge of the secondary battery 300 is prohibited, and it results in protection of the secondary battery 300.

The short-circuit detection circuit 240 is also connected to the detection input terminal V−. When the short-circuit detection circuit 240 detects a short circuit between the external connection terminals P+(PA) and P−(PA) during discharging, the short-circuit detection circuit 240 sends a short-circuit detected signal to the protection control logic circuit 250. Responsive to the short-circuit detected signal, the protection control logic circuit 250 sends the signal having the logic low level from the overdischarge detection output terminal DOUT to the first gate G1 of the first field effect transistor FET1. Thereby, the first field effect transistor FET1 is turned off, the discharge of the secondary battery 300 is prohibited, and it results in protection of the secondary battery 300.

Such a battery pack 100 illustrated in FIG. 1 is disadvantageous in that it is possible to easily manufacture counterfeit goods of the battery pack 100. This is because the conventional battery pack 100 comprises no security function. Among this specification, the “security function” means a function for precluding inferior and dangerous counterfeit goods to improve safety in the secondary battery 300. In other words, the security function means a function for certificating or authenticating a security identifier (ID) to preclude, as the counterfeit goods, ones which cannot certificate or authenticate the security ID. In the conventional battery pack 100 illustrated in FIG. 1, it is possible to easily manufacture the counterfeit goods of the battery pack 100. This is because the conventional battery pack 100 has no function for certificating or authenticating the security ID, as mentioned in the preamble of the instant specification.

For this purpose, a proposal is made a new battery pack with an integrated circuit (IC) or a microcomputer for the security function. Such a new battery pack is called a security-equipped battery pack.

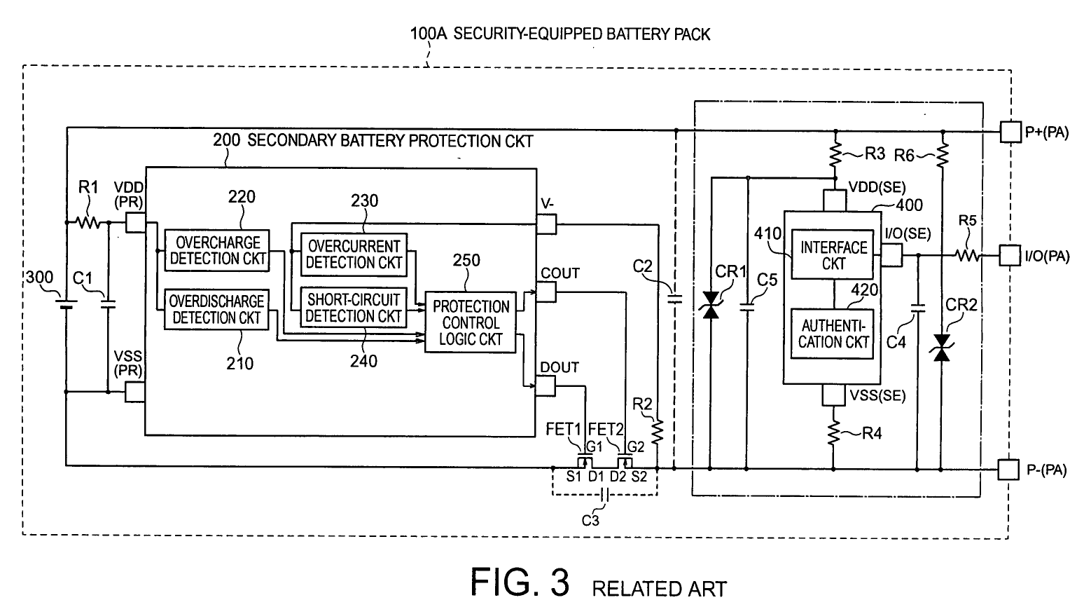

Referring to FIG. 3, a related security-equipped battery pack 100A will be described in order to facilitate an understanding of the present invention. The illustrated security-equipped battery pack 100A is similar in structure to the conventional battery pack 100 illustrated in FIG. 1 except that the security-equipped battery pack 100A further comprises a security circuit (security IC) and external circuitry which will later be described. Accordingly, ones having functions similar to those illustrated in FIG. 1 are depicted at the same reference symbols and description thereof is omitted in order to simplify description.

The security-equipped battery pack 100A has a pack input/output terminal (communication terminal) I/O(PA) for security. The security circuit 400 has a security power source terminal VDD(SE), a security ground terminal VSS(SE), and a security input/output terminal (a communication terminal) I/O(SE). The security power source terminal VDD(SE) of the security circuit 400 is connected to the pack positive electrode terminal P+(PA) of the security-equipped battery pack 100A through a resistor R3. The security ground terminal VSS(SE) of the security circuit 400 is connected to the pack negative electrode terminal P−(PA) of the security-equipped battery pack 100A through a resistor R4. The security input/output terminal (communication terminal) I/O(SE) of the security circuit 400 is connected to the pack input/output terminal (communication terminal) I/O(PA) through a resistor R5. The security input/output terminal (communication terminal) I/O(SE) of the security circuit 400 is connected to the pack negative electrode terminal P−(PA) of the security-equipped battery pack 100A through a capacitor C4. Between the security power source terminal VDD(SE) of the security circuit 400 and the pack negative electrode terminal P−(PA) of the security-equipped battery pack 100A, a capacitor C5 and a varistor or a voltage-dependent resistor CR1 are connected in parallel with each other. Between the pack positive electrode terminal P+(PA) of the security-equipped battery pack 100A and the security input/output terminal (communication terminal) I/O(SE)of the security circuit 400, a resistor R6 is connected. Between the security input/output terminal (communication terminal) I/O(SE) of the security circuit 400 and the pack negative electrode terminal P−(PA) of the security-equipped battery pack 100A, a varistor or a voltage-dependent resistor CR2 is connected. The above-mentioned external circuitry of the security circuit 400 is for protecting static electricity.

The security circuit 400 comprises an interface circuit 410 and an authentication circuit or a certification circuit 420. The authentication circuit 420 is connected to the security input/output terminal I/O(SE) of the security circuit 400 through the interface circuit 410. The interface circuit 410 is for interfacing to a portable unit body which will later be described. In the manner which will later be described, the authentication circuit 420 has a function for calculating an identifier (ID) obtained by encrypting a random number received from the portable unit body to return the identifier (ID) to the portable unit body.

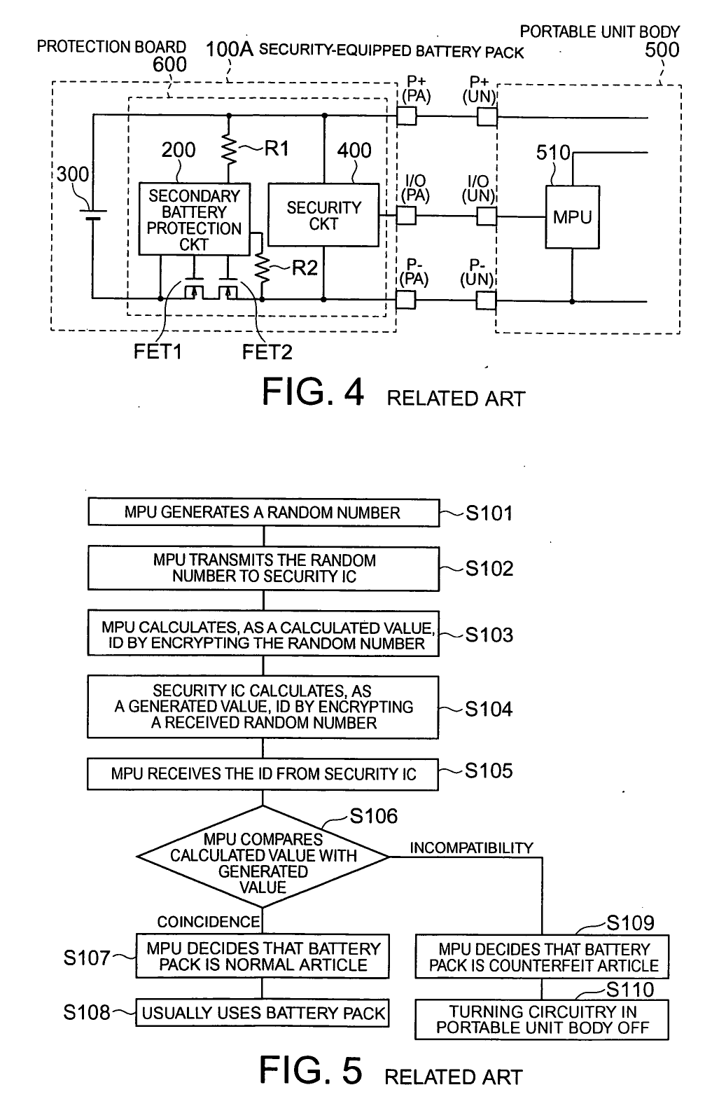

FIG. 4 shows a state where the security-equipped battery pack 100A is connected to the portable unit body depicted at 500. The portable unit body 500 may be a game equipment, a handheld terminal, a personal digital assistance (PDA), a cellular phone, or the like. FIG. 4 illustrates only schematic of the security-equipped battery pack 100A and the external circuitry for the security circuit 400 is omitted from FIG. 4. The secondary battery protection circuit 200 and the security circuit 400 are mounted on a protection board 600.

The portable unit body 500 has a unit positive electrode terminal P+(UN), a unit negative electrode terminal P−(UN), and a unit input/output terminal I/O(UN) which are connected to the pack positive electrode terminal P+(PA), the pack negative electrode terminal P−(PA), and the pack input/output terminal I/O(PA) of the security-equipped battery pack 100A, respectively. The portable unit body 500 comprises a microprocessor (MPU) 510 which is connected to the unit input/output terminal I/O(UN).

Referring to FIG. 5 in addition to FIG. 4, description will be made as regards a security function of the security-equipped battery pack 100A. Although there are various schemes with regard to the security function, description will proceed to a challenge response scheme as one of the various schemes. In the example being illustrated, the microprocessor (MPU) 510 is a challenge side while the security-equipped battery pack 100A is a response side. The challenge response scheme is a scheme which comprises the steps of sending a random number from the challenge side (the microprocessor 510) to the response side (the security-equipped battery pack 100A), of calculates ciphers in the challenge side and the response side, and of checking whether or not the calculated ciphers coincides with each other in the challenge side.

At first, the microprocessor (MPU) 510 generates a random number at a step S101. The step S101 is followed by a step S102 at which the microprocessor (MPU) 510 transmits the random number to the security circuit 400. The step S102 is succeeded by a step S103 at which the microprocessor (MPU) 510 calculates, as a calculated value, an identifier (ID) obtained by encrypting the random number. The step S103 proceeds to a step S104 at which the authentication circuit 420 in the security circuit 400 calculates, a generated value, an identity (ID) obtained by encrypting the received random number. The step S104 is followed by a step S105 at which the microprocessor (MPU) 510 receives the ID from the security circuit 400. The step S105 is succeeded by a step S106 at which the microprocessor (MPU) 510 compares the calculated value in the microprocessor (MPU) 510 with the generated value in the security circuit 400.

If the calculated value and the generated value coincide with each other at the step S106, the step S106 proceeds to a step S107 at which the microprocessor (MPU) 510 decides that the security-equipped battery pack 100A is a normal article. Accordingly, it is possible to usually use the security-equipped battery pack 100A (step S108). On the other hand, if the calculated value and the generated value are incompatible with each other at the step S106, the step S106 is followed by a step S109 at which the microprocessor (MPU) 510 decides that the security-equipped battery pack 100A is a counterfeit article. Accordingly, the microprocessor (MPU) 510 turns circuitry in the portable unit body 500 side off (step S110).

According to the security-equipped battery pack 100A having the above-mentioned structure, it is difficult to manufacture any counterfeit good of the security-equipped battery pack 100A.

However, it is feared that the following problems occur in the related security-equipped battery pack 100A. That is, the related security-equipped battery pack 100A comprises not only the above-mentioned conventional secondary battery protection circuit 200 but also the purpose-built security circuit 400 with a function for authenticating or certificating the security ID and external circuitry which are mounted on the protection board 600. As a result, a lot of parts are required in the related security-equipped battery pack 100A and a mounted area occupied on the protection board 600 is large. It is therefore disadvantageous in that the related security-equipped battery pack 100A increases in cost greatly on the whole. In addition, inasmuch as turning-on/off of the related security-equipped battery pack 100A in itself is carried out by the secondary battery protection circuit 200, turning-on/off caused by the ID authentication or certification using the security circuit 400 is controlled by the portable unit body 500 side. Accordingly, it is impossible to power off by the related security-equipped battery pack 100A singly, as mentioned also in the preamble the instant specification.

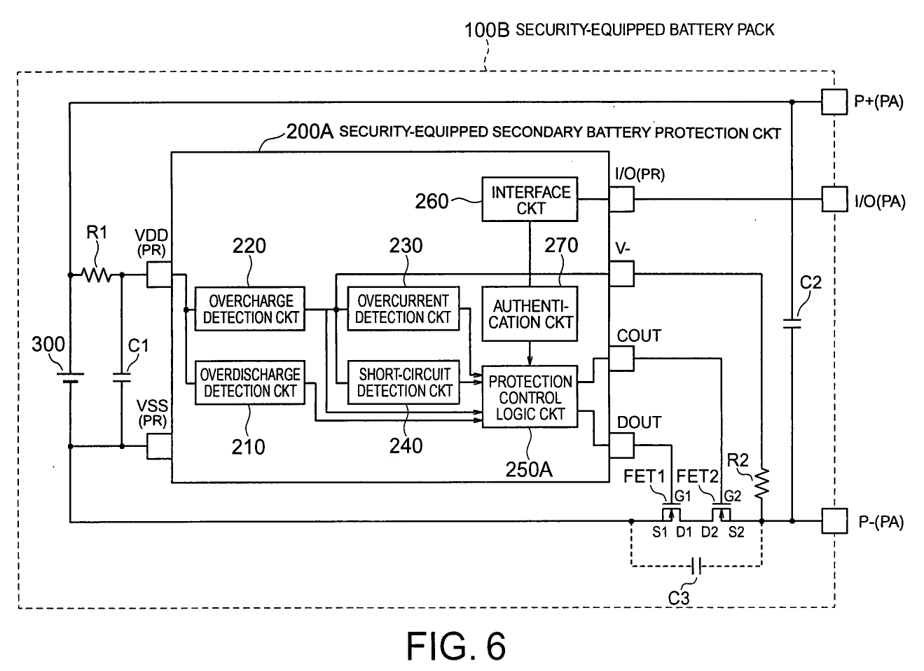

Referring to FIG. 6, the description will proceed to a security-equipped battery pack 100B according to an embodiment of this invention. The security-equipped battery pack 100B is similar in structure to the conventional battery pack 100 illustrated in FIG. 1 except that the secondary battery protection circuit is modified from that illustrated in FIG. 1 as will later become clear. The secondary battery protection circuit is therefore depicted at 200A. Accordingly, ones having functions similar to those illustrated in FIG. 1 are depicted at the same reference symbols and description thereof is omitted in order to simplify description.

The secondary battery protection circuit 200A has a protection input/output terminal I/O(PR). The protection input/output terminal I/O(PR) of the secondary battery protection circuit 200A is connected to the pack input/output terminal I/O(PA) of the security-equipped battery pack 100B. The secondary battery protection circuit 200A is similar in structure to the conventional secondary battery protection circuit 200 illustrated in FIG. 1 except that the secondary battery protection circuit 200A further comprises an interface circuit 260 and an authentication circuit 270 and that the protection control logic circuit is modified from that illustrated in FIG. 1 as will later become clear. The protection control logic circuit is therefore depicted at 250A.

The authentication circuit 270 is connected to the protection input/output terminal I/O(PR) of the secondary battery protection circuit 200A through the interface circuit 260 and is connected to the protection control logic circuit 250A. Inasmuch as the secondary battery protection circuit 200A comprises the authentication circuit 270 for a security function in the manner which is described above, the security battery protection circuit 200A is also called a security-equipped secondary battery protection circuit. The interface circuit 260 is for interfacing to the portable unit body which will later be described. In the manner which will later be described, the authentication circuit 270 calculates an identifier (ID) obtained by encrypting a random number received from the portable unit body to return the identifier (ID) to the portable unit body.

In the security-equipped secondary battery protection circuit 200A, a combination of the overdischarge detection circuit 210, the overcharge detection circuit 220, the overcurrent detection circuit 230, the short-circuit detection circuit 240, and the protection control logic circuit 250A serves as a protection arrangement for protecting the secondary battery 300, by turning the discharge control switch FET1 and the charge control switch FET2 on and off, so as to the secondary battery 300 from overdischarging and overcharging. A combination of the interface circuit 260 and the authentication circuit 270 acts as a security arrangement for precluding counterfeit goods or articles of a battery back.

Inasmuch as the security-equipped battery pack 100B comprises the security-equipped secondary battery protection circuit 200A, it is possible to share the external circuitry for the security circuit and it results in unnecessary to add parts compared with the related security-equipped battery pack 100A illustrated in FIG. 3. In addition, inasmuch as an authentication function and turning-on/off of the security-equipped battery pack 100B can be interlocked, it is possible to power off by the security-equipped battery pack 100B singly. Furthermore, it is possible to extend variations of control methods such as a control method by the portable unit body, a control method by the security-equipped battery pack 100B.

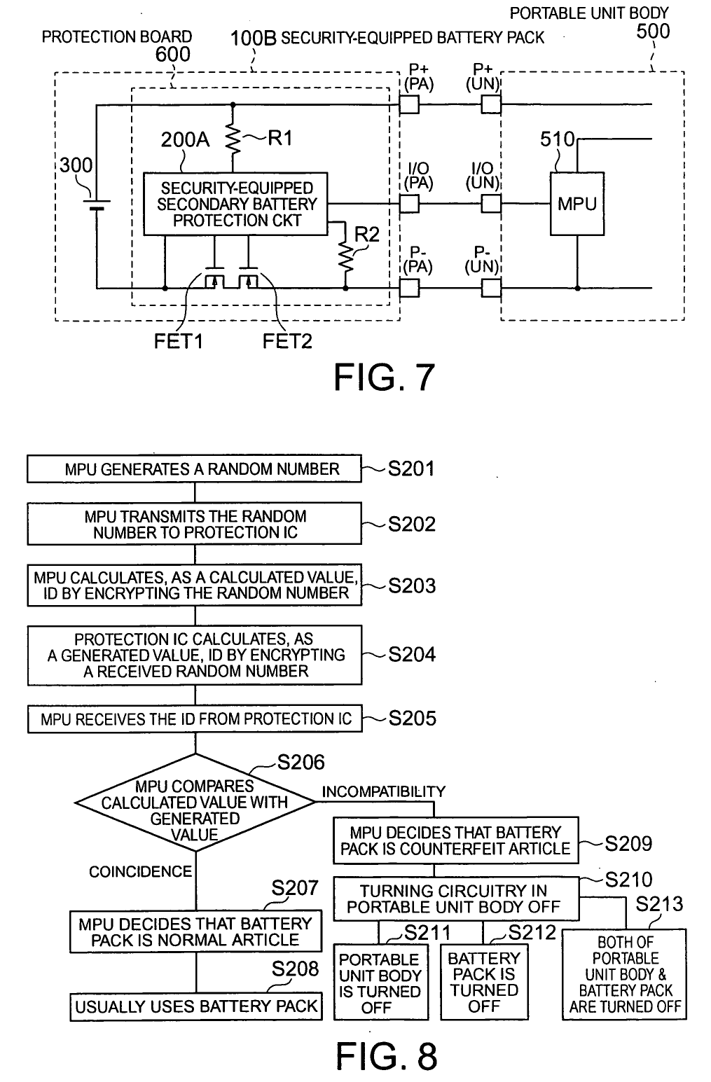

FIG. 7 shows a state where the security-equipped battery pack 100B is connected to the portable unit body 500. The security-equipped secondary battery protection circuit 200A is mounted on the protection board 600.

The unit positive electrode terminal P+(UN), the unit negative electrode terminal P−(UN), and the unit input/output terminal I/O(UN) of the portable unit body 500 are connected to the pack positive electrode terminal P+(PA), the pack negative electrode terminal P−(PA), and the pack input/output terminal I/O(PA) of the security-equipped battery pack 100B, respectively. The portable unit body 500 comprises the microprocessor (MPU) 510 which is connected to the unit input/output terminal I/O(UN).

In the manner which is well known in the art, there are various security schemes. For example, the security scheme may be the challenge response scheme, a continuous challenge scheme, a continuous response (random generation) scheme, or an ID data reading scheme.

Referring to FIG. 8 in addition to FIG. 7, description will be made as regards a first example of the security function of the security-equipped battery pack 100B. FIG. 8 shows an example in a case where a scheme of the security function is the challenge response scheme.

At first, the microprocessor (MPU) 510 generates a random number at a step S201. The step S201 is followed by a step S202 at which the microprocessor (MPU) 510 transmits the random number to the security-equipped secondary battery protection circuit 200A. The step S202 is succeeded by a step S203 at which the microprocessor (MPU) 510 calculates, as a calculated value, an identifier (ID) obtained by encrypting the random number. The step S203 proceeds to a step S204 at which the security-equipped secondary battery protection circuit 200A calculates, as a generated value, an identifier (ID) obtained by encrypting the received random number. The step S204 is followed by a step S205 at which the microprocessor (MPU) 510 receives the ID from the security-equipped secondary battery protection circuit 200A. The step S205 is succeeded by a step S206 at which the microprocessor (MPU) 510 compares the calculated value in the microprocessor (MPU) 510 with the generated value in the security-equipped secondary battery protection circuit 200A.

If the calculated value and the generated value coincide with each other at the step S206, the step S206 proceeds to a step S207 at which the microprocessor (MPU) 510 decides that the security-equipped battery pack 100B is a normal article. Accordingly, it is possible to usually use the security-equipped battery pack 100B (step S208). On the other hand, if the calculated value and the generated value are incompatible with each other at the step S206, the step S206 is followed by a step S209 at which the microprocessor (MPU) 510 decides that the security-equipped battery pack 100B is a counterfeit article. Accordingly, the microprocessor (MPU) 510 turns circuitry in the portable unit body 500 side off (step S210). In this event, the portable unit body 500 may be turned off (step S211), the security-equipped battery pack 100B may be turned off (step S212), or both of the portable unit body 500 and the security-equipped battery pack 100B may be turned off (step S213).

It will be assumed that the security-equipped battery pack 100B is turned off. In this event, the microprocessor (MPU) 510 sends a power-off signal to the protection control logic circuit 250A through the interface circuit 260 and the authentication circuit 270. Responsive to the power-off signal, the protection control logic circuit 250A sends the signal having the logic low level from the overdischarge detection output terminal DOUT to the first gate G1 of the first field effect transistor FET1. Therefore, the first field effect transistor FET1 is turned off, discharge of the secondary battery 300 is prohibited, and the secondary battery 300 is protected.

In addition, a method of protecting the secondary battery 300 is not restricted to it. For instance, responsive to the power-off signal, the protection control logic circuit 250A may send the signal having the logic low level from the overcharge detection output terminal COUT to the second gate G2 of the second field effect transistor FET2 to turn the second field effect transistor FET1 off. Alternatively, responsive to the power-off signal, the protection control logic circuit 250A may send the signal having the logic low level from both of the overdischarge detection output terminal DOUT and the overcharge detection output terminal COUT to the first and the second gates G1 and G2 of the first and the second field effect transistors FET1 and FET2 to turn the first and the second field effect transistors FET1 and FET2.

Inasmuch as the secondary battery protection circuit 200A has the security function according to this invention in the manner which is described above, it is possible to manufacture the security-equipped battery pack 100B at low cost.

The security-equipped secondary battery protection circuit 200A may make the security function and the battery protection function operate independently or may make the security function and the battery protection function operate collaboratively. It will be assumed that the security-equipped secondary battery protection circuit 200A makes the security function and the battery protection function operate collaboratively. In this event, the security-equipped secondary battery protection circuit 200A forcefully turns the first and/or the second first effect transistors FET1 and/or FET2 to make discharge, charge, or discharge and charge of the secondary battery 300 stop. That is, the security-equipped battery pack 100B controls turning-on/off of a power supply.

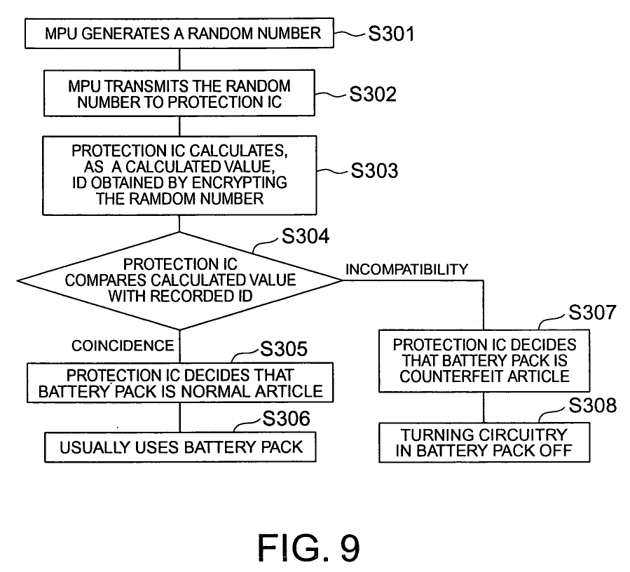

Referring now FIG. 9 in addition to FIG. 7, description will be made as regards a second example of the security function of the security-equipped battery pack 100B. FIG. 9 shows an example in a case where a scheme of the security function is the continuous challenge scheme. The continuous challenge scheme is a scheme comprising the steps of sending a random number from the microprocessor (MPU) 510 and of authenticating at the security-equipped secondary battery protection circuit 200A to carry out decision. Accordingly, security strength is improved in the continuous challenge scheme by keeping on sending the random number.

At first, the microprocessor (MPU) 510 generates a random number at a step S301. The step S301 is followed by a step S302 at which the microprocessor (MPU) 510 transmits the random number to the security-equipped secondary battery protection circuit 200A. The step S302 is succeeded by a step S303 at which the security-equipped secondary battery protection circuit 200A calculates, as a calculated value, an identifier (ID) obtained by encrypting the received random number. The step S303 proceeds to a step S304 at which the authentication circuit 270 of the security-equipped secondary battery protection circuit 200A compares the calculated value with a preliminarily recorded identifier (ID).

If the calculated value and the recorded ID coincide with each other at the step S304, the step S304 is followed by a step S305 at which the authentication circuit 270 in the security-equipped secondary battery protection circuit 200A decides that the security-equipped battery pack 100B is a normal article. Accordingly, it is possible to usually use the security-equipped battery pack 100B (step S306). On the other hand, if the calculated value and the recorded ID are incompatible with each other at the step S304, the step S304 is succeeded by a step S307 at which the authentication circuit 270 in the security-equipped secondary battery protection circuit 200A decides that the security-equipped battery pack 100B is a counterfeit article. Accordingly, the security-equipped secondary battery protection circuit 200A turns circuitry in the security-equipped battery pack 100B off (step S308).

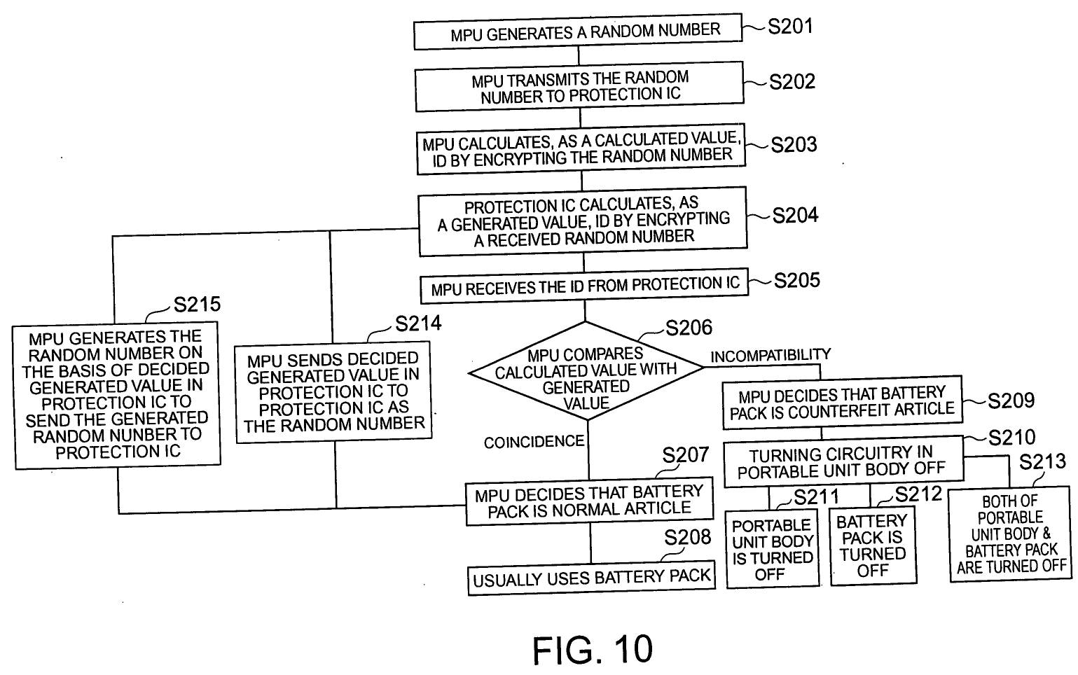

Referring now FIG. 10 in addition to FIG. 7, description will be made as regards a third example of the security function of the security-equipped battery pack 100B. FIG. 10 shows an example in a case where a scheme of the security function is the continuous response scheme.

As shown in FIG. 10, the continuous response scheme is a scheme in which an authentication flow itself is similar to that of the challenge response scheme illustrated in FIG. 8 and authentication is continued by generating the calculated value as the random number or by generating the random number on the basis of the calculated value after the authentication comes to an end.

More specifically, after the step S207, the microprocessor (MPU) 510 sends the decided generated value in the security-equipped secondary battery protection circuit 200A to the security-equipped secondary battery protection circuit 200A as the random number (step S214) and a processing is turned back to the step S204. Alternatively, after the step S207, the microprocessor (MPU) 510 generates the random number on the basis of the decided generated value in the security-equipped secondary battery protection circuit 200A to send the generated random number to the security-equipped secondary battery protection circuit 200A (step S215) and a processing is turned back to the step S204.

As apparent from the above description, each of the continuous challenge scheme and the continuous response scheme has an improved security strength compared with the challenge response scheme because encryption is repeated in the continuous challenge scheme and the continuous response scheme.

Now, description will proceed to the ID data reading scheme. The ID data reading scheme is a scheme where the microprocessor (MPU) 510 performs authentication by reading the data from the security-equipped battery pack 100B without calculation. Accordingly, the ID data reading scheme has a vastly lower security strength than the above-mentioned other schemes because encryption is not performed.

According to this invention, it is possible to make an turning-on/off control of the power supply carry out in the security-equipped battery pack 100B or the portable unit body 500 on the basis of differences of the schemes in the security function.

More specifically, in the challenge response scheme, the continuous response (random generating) scheme, and the ID data reading scheme, the portable unit body 500 controls the turning-on/off of the power supply. In the continuous challenge scheme, the security-equipped battery pack 100B controls the turning-on/off of the power supply. In other words, among the above-mentioned four schemes, the security-equipped battery pack 100B singly turns the power supply on or off in the continuous challenge scheme alone. Inasmuch as it is desirable that the power supply is turned off by the security-equipped battery pack 100B singly from the viewpoint of the security function of the security-equipped battery pack 100B, the continuous challenge scheme is desirable as the scheme of the security function in the security-equipped secondary battery protection circuit 100B.

While this invention has thus far been described in conjunction with a preferred embodiment thereof, it will now be readily possible for those skilled in the art to put this invention into various other manners. For example, although the security-equipped secondary battery protection circuit 200A comprises the authentication circuit 270 as the security arrangement in the above-mentioned embodiment, the security-equipped secondary battery protection circuit may comprise, as the security arrangement, one of other security circuits. Although the protection arrangement of the security-equipped secondary battery protection circuit 200A comprises a combination of the overdischarge detection circuit 210, the overcharge detection circuit 220, the overcurrent detection circuit 230, the short-circuit detection circuit 240, and the protection control logic circuit 250A in the above-mentioned embodiment, the overcurrent detection circuit 230 and/or the short-circuit detection circuit may be omitted from the protection arrangement. In other words, the protection arrangement may comprise a combination of the overdischarge detection circuit 210 and the overcharge detection circuit 220, and the protection control logic circuit 250A, or a combination of the overdischarge detection circuit 210, the overcharge detection circuit 220, the overcurrent detection circuit 230, and the protection control logic circuit 250A, or a combination of the overdischarge detection circuit 210, the overcharge detection circuit 220, the short-circuit detection circuit 240, and the protection control logic circuit 250A.

What is claimed is:

1. A secondary battery protection circuit (200A) comprising:
a protection arrangement (210, 220, 230, 240, 250A) for protecting a secondary battery (300), by turning a discharge control switch (FET1) and a charge control switch (FET2) on and off, so as to prevent said secondary battery from overdischarging and overcharging; and
a security arrangement (260, 270) for precluding counterfeit goods of a battery pack.

2. The secondary battery protection circuit as claimed in claim 1, wherein said protection arrangement comprises:
an overdischarge detection circuit (210) for detecting an overdischarge in said secondary battery;
an overcharge detection circuit (220) for detecting an overcharge in said secondary battery; and
a protection control logic circuit (250A), connected to said overdischarge detection circuit and said overcharge detection circuit, for controlling turning-on/off of said discharge control switch (FET1) and said charge control switch (FET2).

3. The secondary battery protection circuit as claimed in claim 2, wherein said security arrangement comprises:
an interface circuit (260) for interfacing to a portable unit body (500); and
an authentication circuit (270), connected to said interface circuit, for calculating an identifier obtained by encrypting a random number received from the portable unit body to return the identifier to the portable unit body.

4. The secondary battery protection circuit as claimed in claim 3, wherein said authentication circuit is connected to said protection control logic circuit, said authentication circuit making said protection control logic circuit turn at least one of said discharge control switch (FET1) and said charge control switch (FET2) off when decision of the counterfeit goods is made.

5. The secondary battery protection circuit as claimed in claim 1, wherein said protection arrangement comprises:
an overdischarge detection circuit (210) for detecting an overdischarge in said secondary battery;
an overcharge detection circuit (220) for detecting an overcharge in said secondary battery;
an overcurrent detection circuit (230) for detecting an overcurrent in said secondary battery; and
a protection control logic circuit (250A), connected to said overdischarge detection circuit, said overcharge detection circuit, and said overcurrent detection circuit, for controlling turning-on/off of said discharge control switch (FET1) and said charge control switch (FET2).

6. The secondary battery protection circuit as claimed in claim 5, wherein said security arrangement comprises:
an interface circuit (260) for interfacing to a portable unit body (500); and
an authentication circuit (270), connected to said interface circuit, for calculating an identifier obtained by encrypting a random number received from the portable unit body to return the identifier to the portable unit body.

7. The secondary battery protection circuit as claimed in claim 6, wherein said authentication circuit is connected to said protection control logic circuit, said authentication circuit making said protection control logic circuit turn at least one of said discharge control switch (FET1) and said charge control switch (FET2) off when decision of the counterfeit goods is made.

8. The secondary battery protection circuit as claimed in claim 1, wherein said protection arrangement comprises:
an overdischarge detection circuit (210) for detecting an overdischarge in said secondary battery;
an overcharge detection circuit (220) for detecting an overcharge in said secondary battery;
a short-circuit detection circuit (240) for detecting a short circuit between external connection terminals (P+(PA), P−(PA)); and
a protection control logic circuit (250A), connected to said overdischarge detection circuit, said overcharge detection circuit, and said short-circuit detection circuit, for controlling turning-on/off of said discharge control switch (FET1) and said charge control switch (FET2).

9. The secondary battery protection circuit as claimed in claim 8, wherein said security arrangement comprises:
an interface circuit (260) for interfacing to a portable unit body (500); and
an authentication circuit (270), connected to said interface circuit, for calculating an identifier obtained by encrypting a random number received from the portable unit body to return the identifier to the portable unit body.

10. The secondary battery protection circuit as claimed in claim 9, wherein said authentication circuit is connected to said protection control logic circuit, said authentication circuit making said protection control logic circuit turn at least one of said discharge control switch (FET1) and said charge control switch (FET2) off when decision of the counterfeit goods is made.

11. The secondary battery protection circuit as claimed in claim 1, wherein said protection arrangement comprises:
an overdischarge detection circuit (210) for detecting an overdischarge in said secondary battery;
an overcharge detection circuit (220) for detecting an overcharge in said secondary battery;
an overcurrent detection circuit (230) for detecting an overcurrent in said secondary battery;
a short-circuit detection circuit (240) for detecting a short circuit between external connection terminals (P+(PA), P−(PA)); and
a protection control logic circuit (250A), connected to said overdischarge detection circuit, said overcharge detection circuit, said overcurrent detection circuit, and said short-circuit detection circuit, for controlling turning-on/off of said discharge control switch (FET1) and said charge control switch (FET2).

12. The secondary battery protection circuit as claimed in claim 11, wherein said security arrangement comprises:
an interface circuit (260) for interfacing to a portable unit body (500); and
an authentication circuit (270), connected to said interface circuit, for calculating an identifier obtained by encrypting a random number received from a portable unit body to return the identifier to the portable unit body.

13. The secondary battery protection circuit as claimed in claim 12, wherein said authentication circuit is connected to said protection control logic circuit, said authentication circuit making said protection control logic circuit turn at least one of said discharge control switch (FET1) and said charge control switch (FET2) off when decision of the counterfeit goods is made.

14. A security-equipped battery pack (100B) having a pack positive electrode terminal (P+(PA)), a pack negative electrode terminal (P−(PA)), and a pack input/output terminal (I/O(PA)), said security-equipped battery pack (100B) comprising:
a secondary battery (300) having a cathode connected to the pack positive electrode terminal and an anode;
a discharge control switch (FET1) and a charge control switch (FET2), disposed between the anode and the pack negative electrode terminal, connected in series with each other, said discharge control switch having a discharge control terminal (G1), said charge control switch having a charge control terminal (G2); and
a security-equipped secondary battery protection circuit (200A) having a protection power source terminal (VDD(PR)) connected to the cathode through a first resistor (R1), a protection ground terminal (VSS(PR)) connected to the anode, an overdischarge detection output terminal (DOUT) connected to the discharge control terminal, an overcharge detection output terminal (COUT) connected to the charge control terminal, and a protection input/output terminal (I/O(PR)) connected to the pack input/output terminal (I/O(PA)), wherein said security-equipped secondary battery protection circuit (200A) comprises:
a protection arrangement (210, 220, 230, 240, 250A), connected to the protection power source terminal, the overdischarge detection output terminal, and the overcharge detection output terminal, for protecting said secondary battery (300), by turning said discharge control switch (FET1) and said charge control switch (FET2) on and off, so as to prevent said secondary battery (300) from overdischarging and overcharging; and
a security arrangement (260, 270), connected to the protection input/output terminal, for precluding counterfeit goods of a secondary pack.

15. The security-equipped battery pack as claimed in claim 14, wherein said protection arrangement comprises:
an overdischarge detection circuit (210), connected to the protection power source terminal, for detecting an overdischarge in said secondary battery (300); and
an overcharge detection circuit (220), connected the protection power source terminal, for detecting an overcharge in said secondary battery (300); and
a protection control logic circuit (250A), connected to said overdischarge detection circuit, said overcharge detection circuit, the overdischarge detection output terminal, and the overcharge detection output terminal, for controlling turning-on/off of said discharge control switch (FET1) and said charge control switch (FET2).

16. The security-equipped battery pack as claimed in claim 15, wherein said security arrangement comprises:
an interface circuit (260), connected to the protection input/output terminal, for interfacing to a portable unit body (500); and
an authentication circuit (270), connected to said interface circuit, for calculating an identifier obtained by encrypting a random number received from the portable unit body to return the identifier to the portable unit body.

17. The security-equipped battery pack as claimed in claim 16, wherein said authentication circuit (270) is connected to said protection control logic circuit (250A), said authentication circuit making said protection control logic circuit turn at least one of said discharge control switch (FET1) and said charge control switch (FET2) off when decision of the counterfeit goods is made.

18. The security-equipped battery pack as claimed in claim 14, said security-equipped secondary battery protection circuit (200A) further having an detection input terminal (V−) connected to the pack negative electrode terminal (P−(PA)) through a second resistor (R2), wherein said protection arrangement comprises:
an overdischarge detection circuit (210), connected to the protection power source terminal, for detecting an overdischarge in said secondary battery (300);
an overcharge detection circuit (220), connected the protection power source terminal, for detecting an overcharge in said secondary battery (300);
an overcurrent detection circuit (230), connected to the detection input terminal, for detecting an overcurrent in said secondary battery (300); and
a protection control logic circuit (250A), connected to said overdischarge detection circuit, said overcharge detection circuit, said overcurrent detection circuit, the overdischarge detection output terminal, and the overcharge detection output terminal, for controlling turning-on/off of said discharge control switch (FET1) and said charge control switch (FET2).

19. The security-equipped battery pack as claimed in claim 18, wherein said security arrangement comprises:
an interface circuit (260), connected to the protection input/output terminal, for interfacing to a portable unit body (500); and
an authentication circuit (270), connected to said interface circuit, for calculating an identifier obtained by encrypting a random number received from the portable unit body to return the identifier to the portable unit body.

20. The security-equipped battery pack as claimed in claim 19, wherein said authentication circuit (270) is connected to said protection control logic circuit (250A), said authentication circuit making said protection control logic circuit turn at least one of said discharge control switch (FET1) and said charge control switch (FET2) off when decision of the counterfeit goods is made.

21. The security-equipped battery pack as claimed in claim 14, said security-equipped secondary battery protection circuit (200A) further having an detection input terminal (V−) connected to the pack negative electrode terminal (P−(PA)) through a second resistor (R2), wherein said protection arrangement comprises:
an overdischarge detection circuit (210), connected to the protection power source terminal, for detecting an overdischarge in said secondary battery (300);
an overcharge detection circuit (220), connected the protection power source terminal, for detecting an overcharge in said secondary battery (300);
a short-circuit detection circuit (240), connected to the detection input terminal, for detecting a short circuit between the pack positive electrode terminal (P+(PA)) and the pack negative electrode terminal (P−(PA)); and
a protection control logic circuit (250A), connected to said overdischarge detection circuit, said overcharge detection circuit, said short-circuit detection circuit, the overdischarge detection output terminal, and the overcharge detection output terminal, for controlling turning-on/off of said discharge control switch (FET1) and said charge control switch (FET2).

22. The security-equipped battery pack as claimed in claim 21, wherein said security arrangement comprises:
an interface circuit (260), connected to the protection input/output terminal, for interfacing to a portable unit body (500); and
an authentication circuit (270), connected to said interface circuit, for calculating an identifier obtained by encrypting a random number received from the portable unit body to return the identifier to the portable unit body.

23. The security-equipped battery pack as claimed in claim 22, wherein said authentication circuit (270) is connected to said protection control logic circuit (250A), said authentication circuit making said protection control logic circuit turn at least one of said discharge control switch (FET1) and said charge control switch (FET2) off when decision of the counterfeit goods is made.

24. The security-equipped battery pack as claimed in claim 14, said security-equipped secondary battery protection circuit (200A) further having an detection input terminal (V−) connected to the pack negative electrode terminal (P−(PA)) through a second resistor (R2), wherein said protection arrangement comprises:
an overdischarge detection circuit (210), connected to the protection power source terminal, for detecting an overdischarge in said secondary battery (300);
an overcharge detection circuit (220), connected the protection power source terminal, for detecting an overcharge in said secondary battery (300);
an overcurrent detection circuit (230), connected to the detection input terminal, for detecting an overcurrent in said secondary battery (300);
a short-circuit detection circuit (240), connected to the detection input terminal, for detecting a short circuit between the pack positive electrode terminal (P+(PA)) and the pack negative electrode terminal (P−(PA)); and
a protection control logic circuit (250A), connected to said overdischarge detection circuit, said overcharge detection circuit, said overcurrent detection circuit, said short-circuit detection circuit, the overdischarge detection output terminal, and the overcharge detection output terminal, for controlling turning-on/off of said discharge control switch (FET1) and said charge control switch (FET2).

25. The security-equipped battery pack as claimed in claim 24, wherein said security arrangement comprises:
an interface circuit (260), connected to the protection input/output terminal, for interfacing to a portable unit body (500); and
an authentication circuit (270), connected to said interface circuit, for calculating an identifier obtained by encrypting a random number received from the portable unit body to return the identifier to the portable unit body.

26. The security-equipped battery pack as claimed in claim 25, wherein said authentication circuit (270) is connected to said protection control logic circuit (250A), said authentication circuit making said protection control logic circuit turn at least one of said discharge control switch (FET1) and said charge control switch (FET2) off when decision of the counterfeit goods is made.
